(19) United States
(12) Patent Application Publication
(10) Pub. No.: US 2004/0223737 A1
(43) Pub. Date: Nov. 11, 2004

(54) User created video bookmarks

(76) Inventor: Carolyn Rae Johnson, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/430,105

(22) Filed: May 7, 2003

(51) Int. Cl. H04N 5/783

(52) U.S. Cl. 386/68; 386/95

(57) ABSTRACT

There is provided a method for marking video in a video recording system. A user input is received that specifies a location in a video stream for future reference. A video bookmark is generated to correspond to the specified location.

### BACKGROUND OF THE INVENTION

1. Field of the Invention

The present invention generally relates to video recording systems and, more particularly, to a method and apparatus for allowing a user of a video recording system to create and manage video bookmarks. The video bookmarks allow a user to “jump” to a desired video segment.

2. Background of the Invention

Video recording systems such as Personal Video Recording (PVR) systems and Digital Video Recording (DVR) systems currently allow a user of such systems to record programming events to a hard drive (e.g., as a recorded event) or to a storage buffer. However, these video recording systems do not allow a user to tag or bookmark a particular video segment in a program for later reference purposes. Therefore, should the user wish to return to the video segment at a later time, this cannot be done with rewinding or fast-forwarding to search for the desired segment. For example, if the user wishes to show a particular news clip from a recorded news program to another person, the user must first take the time and effort to fast-forward or rewind to that point.

While playing back recorded events, most PVR/DVR systems store the last played position so that a user can resume the playback of a video program from either the last played position or from the start of the recorded event. However, segments for later reference. The user can only return to the last played position and cannot jump to anywhere else in the recorded event.

Accordingly, it would be desirable and highly advantageous to have a method and apparatus for allowing a user of a video recording system to create and manage video bookmarks. Such video bookmarks would allow a user to “jump” to a desired video segment.

### SUMMARY OF THE INVENTION

The problems stated above, as well as other related problems of the prior art, are solved by the present invention, a method and apparatus for allowing a user of a video recording system to create and manage video bookmarks. The video bookmarks allow the user to “jump” to a desired video segment.

According to an aspect of the present invention, there is provided a method for marking video in a video recording system. A user input is received that specifies a location in a video stream for future reference. A video bookmark is generated to correspond to the specified location.

According to another aspect of the present invention, there is provided an apparatus for marking video in a video recording system. A user input device receives a user input that specifies a location in a video stream for future reference. A video bookmark manager generates a video bookmark to correspond to the specified location.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating a personal video recorder 100, according to an illustrative embodiment of the present invention;

FIG. 2 is a flow diagram illustrating a method for creating and using video bookmarks, according to an illustrative embodiment of the present invention;

FIG. 3 is a screen shot of a paused video banner 300 with a video bookmark option, according to an illustrative embodiment of the present invention;

FIG. 4 is a screen shot of a save and/or rename bookmark dialog box 400, according to an illustrative embodiment of the present invention;

FIG. 5 is a screen shot of a rename bookmark dialog box 500, according to an illustrative embodiment of the present invention; and

FIG. 6 is a screen shot of a video bookmarks list dialog box 600, according to an illustrative embodiment of the present invention.

### DETAILED DESCRIPTION OF THE INVENTION

The present invention is directed to method and apparatus for allowing a user of a video recording system to create and manage video bookmarks. That is, the present invention allows the user of a video recording system (e.g., a DVR, PVR, and so forth) to attach a tag, also referred to herein as a video bookmark, to a video segment stored in the video recording system. The video bookmark would allow the user to move directly to that specific segment of the stored video, rather than requiring the user to fast forward or rewind and search for that segment at a later time. The video bookmarks may be used on video that is stored in a persistent storage device (e.g., a hard drive, a floppy drive, compact disk, etc.) or in a temporary storage device (e.g., a video buffer, etc.).

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

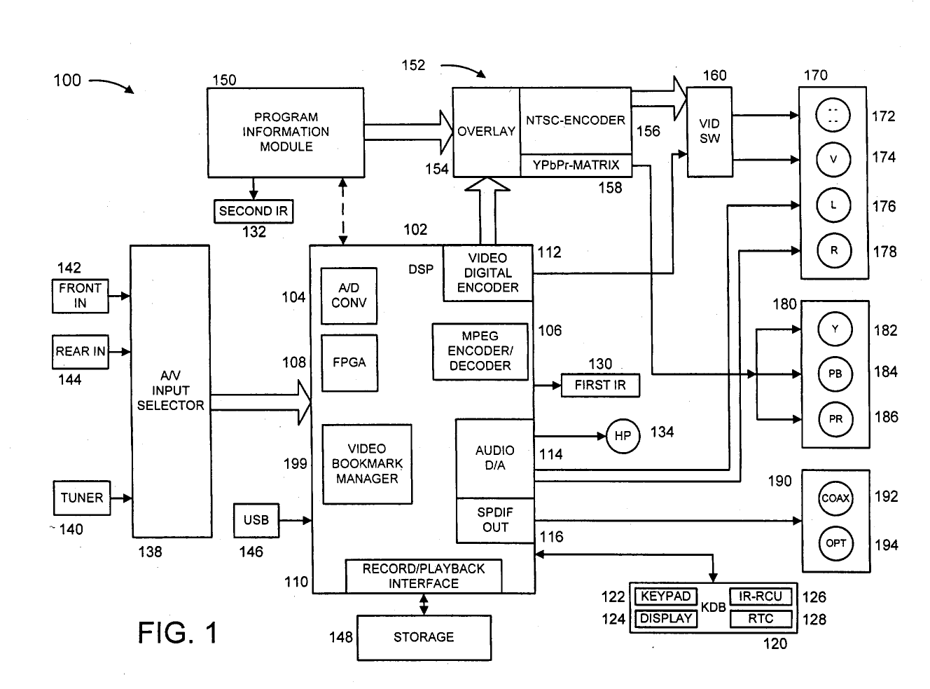

FIG. 1 is a block diagram illustrating a personal video recorder 100, according to an illustrative embodiment of the present invention. The personal video recorder (PVR) 100 can include a digital signal processor (DSP) 102, a key and display board (KDB) 120, a tuner 140, an A/V input selector 138, a USB input 146, a storage device 148, a program information module 150, and a video bookmarks manager 199. Additionally, the PVR 100 can include first and second infra-red (IR) links 130 and 132, a video overlay encoder 152, a video switch 160, a headphone jack 134, a standard A/V component connector block 170, a YPbPr component connector block 180, and a Sony/Phillips digital interface (SPDIF) connector block 190.

The component connector blocks 170, 180 and 190 can provide audio/video signals in a variety of output formats. For example, the standard A/V component connector block 170 can comprise an S-video connector 172 for outputting to a video display video that has been separated into chrominance and luminance video signals and a composite video connector 174 for providing a standard composite video signal. Further, the standard A/V component connector block 170 can comprise left and right audio output connectors, 176 and 178, respectively.

The YPbPr component connector block 180 is typically used for high definition television (HDTV). The YPbPr component connector block 180 comprises a video luminance (Y) output connector 182 for providing an analog video luminance component, a Pb output connector 184 for providing an analog blue color difference (B−Y), and a Pr output connector 186 for providing an analog red color difference (R−Y). Lastly, the SPDIF component connector block 190 comprises a coaxial output 192 and an optical output 194 for outputting digital audio signals via a coaxial cable or fiber optic cable, respectively.

The key and display board 120 can be provided as a user interface for the PVR 100 and can incorporate a keypad 122, a display 124, an IR remote control interface 126 and a real time clock 128. By using the keypad 122 or the IR remote control interface 126, a user can select functions to be executed by the PVR 100. For example, a user can choose to change channels on the PVR 100 or to perform trick mode playback. The real time clock 128 can keep time, which can be shown by the display 124. The display 124 also can show other information as well, for example a trick mode being executed by the PVR 100, a selected channel being recorded by the PVR 100, or an identifier representative of a presentation being shown on a video display.

First and second IR links 130 and 132 form a set of communication links between satellite and non-satellite applications to help simplify the interface between the audio, video, and data streams. The first IR link 130 can be a communication interface between the DSP 102 and other devices having an IR communication link. Notably, the first IR link 130 can be useful for controlling other devices designed specifically for aired or cable television broadcasts or radio broadcasts using standard program guide information. The first IR link 130 also can enable features to simplify the consumer's interaction between devices. For example, the first IR link 130 can enable one touch program recording, as well as other user conveniences. The second IR link 132 can provide an interface between the program information module 150 and other devices having IR communication links. Significantly, the second IR link 132 can be useful for communicating with devices not requiring a direct connection to DSP 102, for example with a cable reception device, a VCR, and so forth.

The DSP 102 can comprise an analog to digital (A/D) converter 104, an MPEG encoder/decoder 106, a field programmable gate array (FPGA) 108, a record/playback interface 110, a video digital encoder 112, an audio digital to analog converter (audio D/A) 114 and a SPDIF output 116. The DSP 102 can further include one or more data busses enabling the different DSP components to communicate with each other and cooperatively process data. Notably, interrupt requests (IRQs) and direct memory addresses (DMAs) can be utilized to facilitate bus communications and data processing.

Audio/Video (A/V) input selector 138 can include a plurality of A/V inputs. For example, the A/V input selector 138 can incorporate an A/V input to receive A/V signals from tuner 140. The A/V input selector 138 also can receive signals form various other input devices as well. For example, a video camera can send A/V signals to the A/V input selector 138 via front A/V input 142, and a VCR can send A/V signals via rear A/V input 144. Significantly, other A/V devices can be connected to the A/V input selector 138 as well.

The A/V input selector 138 can forward the received A/V signals to DSP 102. The DSP's A/D converter 104 can be used to convert A/V signals received in an analog format to a digital format. A/V signals already in digital format can bypass the analog to digital conversion, for example, digital signals received via a universal serial bus (USB) interface 146.

FPGA 108 can provide processing instructions for data received from the A/V input selector 138 or the USB interface 146, depending on the type of data received. For example, if A/V data is received in an uncompressed form, FPGA 108 can forward the A/V data to MPEG encoder/decoder 106 for MPEG compression prior to being sent to the record/playback interface 110. However, if A/V data is received in an MPEG compressed format, FPGA 108 can forward the A/V data straight to the receive/playback interface 110. In either case the FPGA 108 can provide read/write instructions to the record/playback interface 110, which then can store the A/V data onto storage 148.

MPEG encoder/decoder 106 can perform MPEG compression and decompression on digital A/V signals. For example, MPEG encoder/decoder 106 can receive digital A/V signals from A/D converter 104 or USB interface 146, compress the digital A/V signals using an MPEG format, and forward the compressed digital A/V signals to the receive/playback interface 110. The record/playback interface 110 then can store the compressed digital A/V signals to storage 148.

Storage 148 can include one or more data storage devices. For example, a data storage device can be a magnetic storage medium, such as a hard disk drive (HDD), an optical storage medium, such as a digital video disk (DVD), an electronic storage medium, such as random access memory (RAM), a magneto/optical storage medium, or any combination of storage devices.

During playback the record/playback interface 110 can read A/V data from storage 148. The A/V data then can be forwarded to MPEG encoder/decoder 106 for decompression. After decompression the A/V data can be separated into video and audio signals. The audio signal can be forwarded to SPDIF 116 to be output digitally via coaxial output 192 or optical output 194. The audio signal also can be forwarded to audio D/A converter 114 for D/A conversion. After D/A conversion the audio signal can be output via headphone jack 134 and/or left and right audio outputs 176 and 178.

The video signal can be processed by video digital encoder 112, which can perform D/A conversion on the video signal as well as encode the video signal into a variety formats. For example, the video signal can be encoded into an RGB format, separated into luminance and chrominance (Y+C) signals, or encoded into a composite video signal having a National Television Standards Committee (NTSC) format. The composite video and the Y+C video signals can be forwarded to video switch 160, while the RGB video signal can be forwarded to the video overlay encoder 152.

The video overlay encoder 152 can include overlay module 154, NTSC video encoder 156, and YPbPr matrix encoder 158. The overlay module 154 can receive program information from a program information module 150 and graphically overlay the program information onto the video signal. The program information module 150 can extract the program information from an-on-line program guide or a program guide contained in incoming A/V signals received by the A/V input selector 138 and communicated to the program information module 150 by the DSP 102. The program information can include available programs for each channel as well as program scheduling. Further, for each individual program the program information can include a program identifier, channel information, recording time, program duration, scene data, program credits, and so forth. Other information and graphics may be overlayed onto the video signal as well. For example, a clock, text blocks, user information, menus, icons, pictures, etc. can be overlayed onto the video signal. Typically, information is overlayed onto the video signal when requested by a user or upon some pre-defined event. However, some information, such as a channel identifier, can be continually overlayed over the video signal.

The NTSC video encoder 156 can output the video signal as an NTSC formatted composite video signal, as well as video separated into separate luminance and chrominance signals. The video signals then can be forwarded to the video switch 160. The video switch 160 can be used to select for display either the NTSC encoded video signal or the video signal generated by the video digital encoder 112. Composite video signals from either source can be output via composite video output connector 174, while chrominance and luminance video signals from either source can be output via the S-video output connector 172.

The YPbPr matrix encoder 158 can generate a YPbPr formatted analog video signal. As previously noted, the YPbPr video signal includes a video luminance (Y) component, an analog blue color difference (B−Y), and an analog red color difference (R−Y). The Y component can be output to the Y output connector 182, the (B−Y) difference can be output to the Pb output connector 184 and the (R−Y) difference can be output to the Pr output connector 186.

The video bookmark manager 199 allows a user to create and manage video bookmarks. In a preferred embodiment of the present invention, a video bookmark as used herein is a pointer that points to either a particular location in the video itself at which a segment of interest begins or points to a particular location in memory (e.g., on the HDD) at which is stored the beginning of the segment of interest. Of course, other ways to mark a point in a video, as readily contemplated by one of ordinary skill in the related art, may also be used while maintaining the spirit and scope of the present invention.

It is to be appreciated that in some embodiments of the present invention, some or all of the functions performed by the video bookmark manager 199 may be subsumed by other elements of the PVR 100. For example, DSP 102 and computer programming code stored in storage device 148 may be used to implement the functions performed by the video bookmark manager 199. Moreover, other elements, as readily contemplated by one of ordinary skill in the related art, may be used to implement those functions. Given the teachings of the present invention provided herein, one of ordinary skill in the related art will contemplate these and various other implementations and configurations of the present invention, while maintaining the spirit and scope of the present invention.

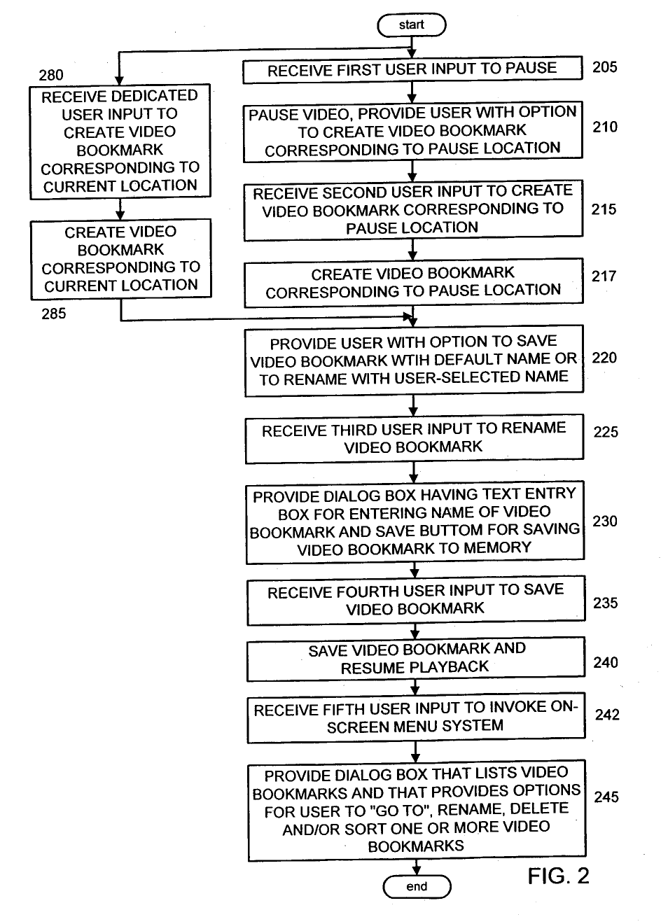

FIG. 2 is a flow diagram illustrating a method for creating and using video bookmarks, according to an illustrative embodiment of the present invention.

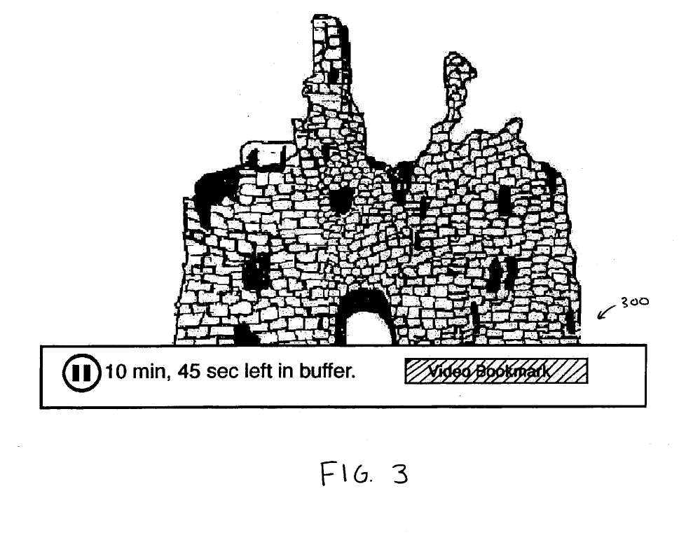

Upon receiving a first user input to pause a playback of a video stream (step 205), the video stream is paused and the user is provided with an option to create a video bookmark that corresponds to the location at which the video stream was paused (step 210). FIG. 3 is a screen shot of a paused video banner 300 with a video bookmark option, according to an illustrative embodiment of the present invention.

Upon receiving a second user input to create the video bookmark (e.g., if the user selects the “Video Bookmark” option in the paused video banner 300 depicted in FIG. 3) (step 215), a video bookmark is created to correspond to the location at which the video stream was paused (step 217), and the method proceeds to step 220.

It is to be appreciated that in another embodiment of the present invention, the video bookmark manager 199 may be configured such that the actuation of a dedicated video bookmark button(s) (i.e., independent of pausing the video stream) automatically results in a video bookmark being created for the corresponding location in the video stream. The dedicated button may be a newly added button or may simply be a combination of two or more existing buttons that are actuated at the same time or in some pre-designated order.

Accordingly, a dedicated user input may be received that requests the creation of a video bookmark at the current location (the location the video was at when the dedicated user input was received, similar to the case above when the video bookmark is created to correspond to the location at which the video was paused) (step 280). In such a case, the video bookmark is generated to correspond to the current location (step 285), and the method proceeds to step 220.

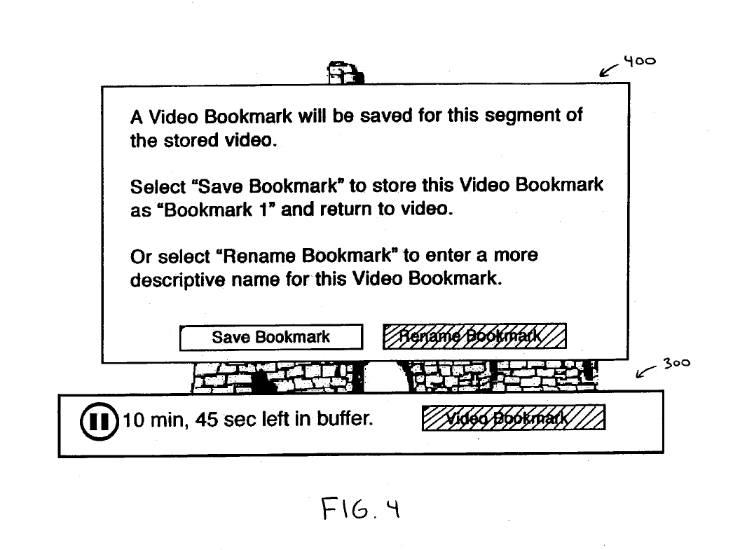

At step 220, the user is provided with an option to save the video bookmark with a default name or to rename the bookmark with a name chosen by the user. FIG. 4 is a screen shot of a save and/or rename bookmark dialog box 400, according to an illustrative embodiment of the present invention.

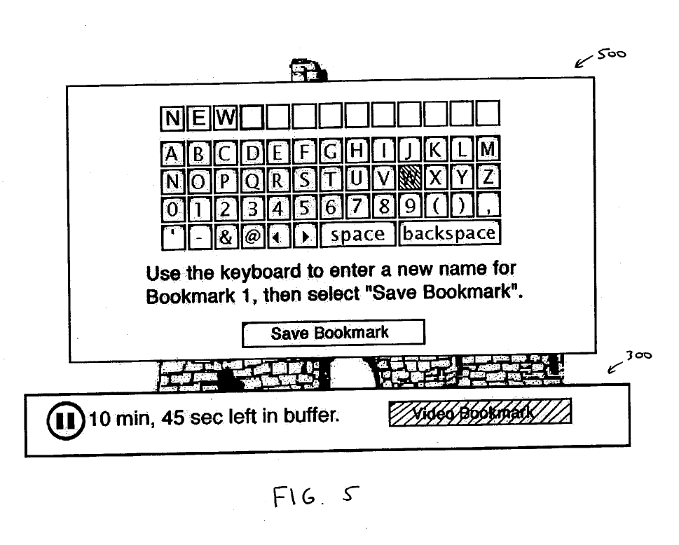

Upon receiving a third user input to rename the video bookmark (step 225), then the user is provided with a dialog box having a text entry box for entering the new name of the video bookmark and further having a save bookmark button for saving the video bookmark in memory (step 230). FIG. 5 is a screen shot of a rename bookmark dialog box 500, according to an illustrative embodiment of the present invention. It is to be appreciated that if the user desires to save the video bookmark with the default name, then the user would simply actuate the “save bookmark” button in the save and/or rename bookmark dialog box 400 depicted in FIG. 4 and the rename bookmark dialog box 500 would not be needed or displayed to the user.

Upon receiving a fourth user input to save the video bookmark (step 235), either with the default name (at step 220) or with a name chosen by the user (at step 230), the video bookmark is saved in memory and playback of the video stream is resumed (step 240).

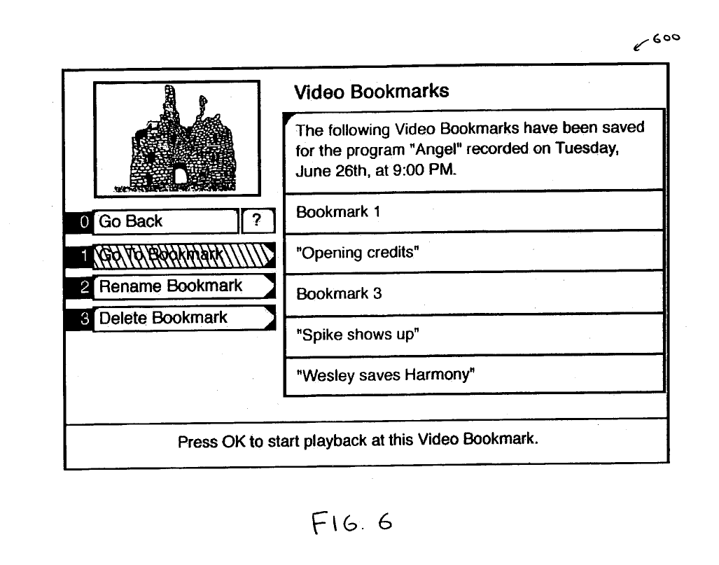

Upon receiving a fifth user input to invoke an on-screen menu system of the video recording system (step 242), the user is provided with a video bookmarks list dialog box that lists all of the video bookmarks for one or more recorded events and that provides options for a user to “go to”, rename, delete, and/or sort one or more bookmarks (step 245). FIG. 6 is a screen shot of a video bookmarks list dialog box 600, according to an illustrative embodiment of the present invention. It is to be appreciated that while the dialog box 600 shown in FIG. 6 lists only the video bookmarks pertaining to a single recorded event, in other embodiments of the present invention the dialog box 600 may list video bookmarks for more than a single recorded event (e.g., all of the video bookmarks that are stored for all or a subset of all of the events).

The video bookmarks list dialog box 600 allows the user to “go to” a desired video bookmark, by first selecting the “Go To Bookmark” option and second by selecting the desired video bookmark from the list on the right side of the screen. The video bookmarks list dialog box 600 also allows the user to rename or delete a video bookmark, by first selecting the desired option and second by selecting the desired video bookmark from the list. If the user chooses to rename a video bookmark, the user is provided with a dialog box similar to that shown in FIG. 5, which would allow the user to enter and save a name. If the user chooses to delete a video bookmark, the user would first be presented with a confirmation screen to verify that the user indeed intends to delete a video bookmark.

In some embodiments of the present invention (not shown in FIG. 6), the video bookmarks list dialog box provides the user with an option to sort the video bookmarks based on default and/or user specified categories and/or criteria. For example, the video bookmarks may be sorted based on show/program name, video bookmark name, or by some other category and/or criteria as are readily contemplated by one of ordinary skill in the related art.

It is to be appreciated that while the present invention is described herein with respect to banners, menus, dialog boxes, and so forth, the present invention is not limited to these display structures (also referred to as “user interface elements”) and, thus, other structures and the like as readily contemplated by one of ordinary skill in the related art may be employed in implementations of the present invention, while maintaining the spirit and scope of the present invention. The other structures may be, e.g., other display structures (e.g., menus, dialog, boxes, etc.), hardware structures (e.g., switches, buttons, sliders, etc.), and so forth. For example, while the method of FIG. 2 is described using a banner to provide a user with an option to associate a video bookmark with a selected video segment, it is to be appreciated that the present invention is not limited to providing this option using only a banner and, thus, other display structures (e.g., dialog boxes, menus, screens, buttons, and so forth) may also be utilized.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method for marking video in a video recording system, comprising the steps of:
receiving a user input that specifies a location in a video stream for future reference; and
generating a video bookmark to correspond to the specified location.

2. The method of claim 1, further comprising the step of storing the video bookmark.

3. The method of claim 1, further comprising the step of specifying a default name for the video bookmark.

4. The method of claim 1, further comprising the step of providing a user with a capability to at least one of name and rename the video bookmark.

5. The method of claim 1, further comprising the steps of:
including the video bookmark in a list of video bookmarks stored in the video recording system; and
displaying the list of video bookmarks to a user.

6. The method of claim 5, further comprising the step of providing the user with a capability to display the list of video bookmarks in accordance with at least one category specified by the user.

7. The method of claim 6, wherein the at least one category comprises at least one of video bookmark names and program names that correspond to the video bookmarks.

8. The method of claim 1, wherein the user input is a pause command, and the method further comprises the step of receiving another user input to create the video bookmark at the location specified by the pause command.

9. The method of claim 1, wherein the user input is a dedicated request, irrespective of a pause command, for the video bookmark to be created.

10. An apparatus for marking video in a video recording system, comprising:
a user input device for receiving a user input that specifies a location in a video stream for future reference; and
a video bookmark manager for generating a video bookmark to correspond to the specified location.

11. The apparatus of claim 10, further comprising a memory device for storing the video bookmark.

12. The apparatus of claim 10, wherein said video bookmark manager automatically specifies a default name for the video bookmark.

13. The apparatus of claim 10, wherein said video bookmark manager is configured to process user inputs corresponding to at least one of naming and renaming the video bookmark.

14. The apparatus of claim 10, wherein said video bookmark manager automatically includes the video bookmark in a list of video bookmarks stored in the video recording system, and said apparatus further comprises a display (120) for displaying the list of video bookmarks to a user.

15. The apparatus of claim 14, wherein said video bookmark manager sorts the list of video bookmarks in accordance with at least one category specified by the user.

16. The apparatus of claim 15, wherein the at least one category comprises at least one of video bookmark names and program names that correspond to the video bookmarks.

17. The apparatus of claim 10, wherein the user input is a pause command, and said video bookmark manager is adapted to process another user input to create the video bookmark at the location specified by the pause command.

18. The apparatus of claim 10, wherein the user input is a dedicated request, irrespective of a pause command, for the video bookmark to be created.

19. A method for marking video in a video recording system, comprising the steps of:
receiving a pause command for pausing the video during playback;
providing a user with an option to create a video bookmark at a location corresponding to the pause command;
receiving another user input for the video bookmark to be created at the corresponding location; and
generating the video bookmark for the corresponding location.
